(19) United States
(12) Patent Application Publication
(10) Pub. No.: US 2018/0284908 A1
(43) Pub. Date: Oct. 4, 2018

(54) 360 video viewing with point of view set by viewing direction

(71) Applicant: Chris Carmichael, Laguna Niguel, CA (US)

(72) Inventor: Chris Carmichael, Laguna Niguel, CA (US)

(21) Appl. No.: 15/939,540

(22) Filed: Mar. 29, 2018

Related U.S. Application Data
(60) Provisional application No. 62/478,129, filed on Mar. 29, 2017.

(51) Int. Cl. G06F 3/0346; G02B 27/01; G06T 19/00; G06F 3/0485; G06F 3/0481

(52) U.S. Cl. CPC G06F 3/0346; G02B 27/017; G06F 3/04815; G06F 3/0485; G06T 19/006

(57) ABSTRACT

360° video which is viewable from multiple directions based on a direction of pointing of a hardware device. As the hardware device points in from a different direction, the direction of viewing of the video automatically changes. So as the device moves from side to side, the direction of viewing of the video similarly moves from side to side. Embodiments describe the device being a mouse on a computer, where by moving the cursor of the mouse moves the direction of viewing of the video; being a cellular phone where moving the direction of pointing and tilting of the cellular phone moves the direction of viewing of the video; and a virtual reality device, where the virtual reality device shows on its display a different point of view based on the different position of viewing.

This application claims priority from provisional application No. 62/478,129, filed Mar. 29, 2017; the entire contents of which are herewith incorporated by reference.

### BACKGROUND

The inventor of the present application has recognized the importance of immersion in a virtual environment, that is that an environment where the user feels immersed in the environment itself.

One way to immerse the user in such an environment is to allow the user to change their point of view in the virtual environment.

### SUMMARY

A 360° video environment is described where each section of the video can be viewed from a number of different directions that is from any direction around a 360° arc. A viewer can view the content of this 360° video from each of a number of different viewpoints.

The present application describes a system where the direction of pointed of the viewing hardware automatically sets the direction of viewing of the 360° video, without any manual selection being necessary.

### BRIEF DESCRIPTION OF THE DRAWINGS

FIG. 1 shows an exemplary view of a 360 degree view;

FIG. 2 shows a computer system used to view the images and video;

FIGS. 3A, 3B and 3C show different views of the user on a surfboard from different angles;

FIG. 4 shows a flowchart of operation;

FIG. 5 illustrates operation on a cellular phone; and

FIG. 6 illustrates operation with a VR headset.

### DETAILED DESCRIPTION

A 360° view can be viewed from each possible viewpoint around a 360° arc. In one embodiment, each moment in the video can be viewed from any vantage point over 360°, that is, from all possible locations.

Any “moment or “frame” in the video is what is viewed at a specific instant of time. It is to be understood that in a digital sense, there may not be individual frames of the video, but there will still be moments of video that can be viewed or considered as an animation over time.

FIG. 1 shows a single frame, or instant of time of the video. This single frame is viewable from each of a plurality of different directions, so the user can view the video as though the user were viewing from any of a number of different locations adjacent the subject of the video.

FIG. 1 shows a video of a person 100 surfing on a surfboard 105 that is on a wave 110. Over time, the video shows the person moving as the wave moves, and the person's arms and legs may also move. These different movements are captured in the video. From the point of view of the 360 degree video, the user viewing the video can see it from any of the directions as though the user were standing in a different location with the person in the video. For example, the user can view from the left 150 or the right 151, the top 152, the bottom 153, the front 154 or the rear 155. This shows only some of the basic different locations, but in general the video can be viewed from any direction in between those directions. The ability to view from these different directions adds to the immersiveness of the experience of watching the video, since the user can see the scene from any point of view, much the way that viewers view reality.

According to the present application, the user views the video on a device. The direction in which the device is pointing sets automatically the angle from which the video is viewed. Three different devices are described herein, but it should be understood that any device can be used in the same way. In each of these embodiments, the direction of pointing of the video-playing device is pointing changes automatically the position of viewing without the need to make a selection on the display screen or any selection on any user interface at all.

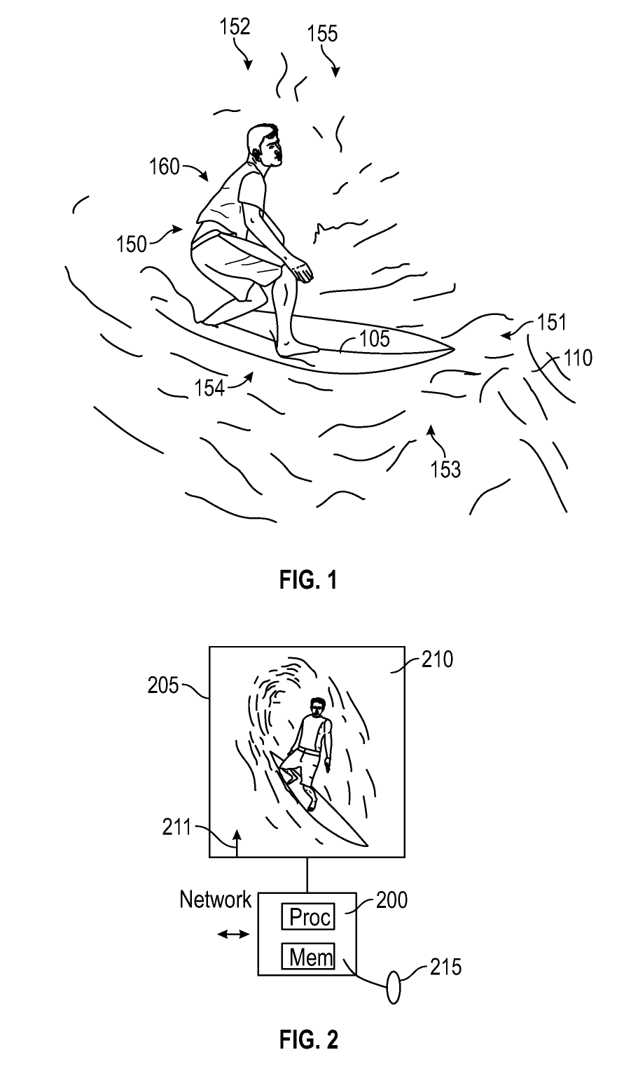

The system can use any of a number of different hardware devices, the first of which is shown in FIG. 2. In FIG. 2, a computer 200 is shown with a screen 205 showing 3D video 210. The screen 205 includes a cursor 211 thereon which is controlled by the user interface, here a mouse 215, from the computer. The position of the cursor 211 automatically sets the direction from which the viewing of the video 210 is occurring. Cursor 211 is shown in FIG. 2 as pointing towards the video 210, from the front, causing viewing of the image or the video 210 from the front.

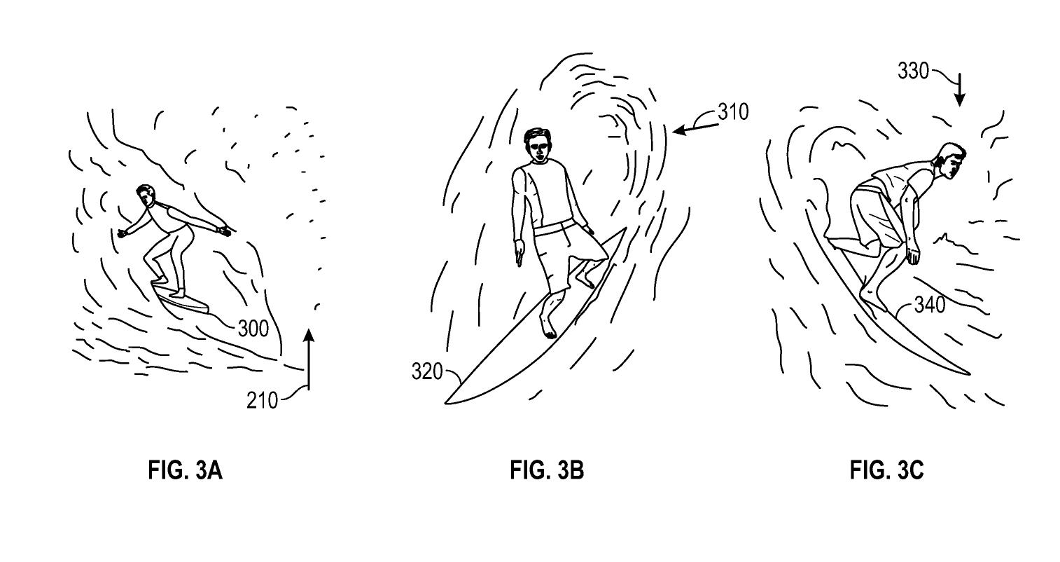

FIG. 3A shows this with the cursor 211 being in a position which causes the image or the video to be viewed from the point of view 300, viewing the scene toward the direction of the surfer's foot.

Similarly, the cursor can be moved over to the side, for example to the right side in the screen 205 in the position shown in FIG. 3B. With the cursor in the position 310, the three-dimensional video is viewed from the side shown as 320 in FIG. 3B, viewing the surfers from the side. That is, by moving the cursor to a different position, the position of viewing the video automatically also changes. This is done without clicking the cursor or the mouse, just pointing the cursor without making

In a similar way, the cursor can be or the video can be viewed from the rear as shown in FIG. 3C, where the cursor is moved to the position 330, at the rear of the display, thus causing the position of viewing 340 to be from the rear of the surfer.

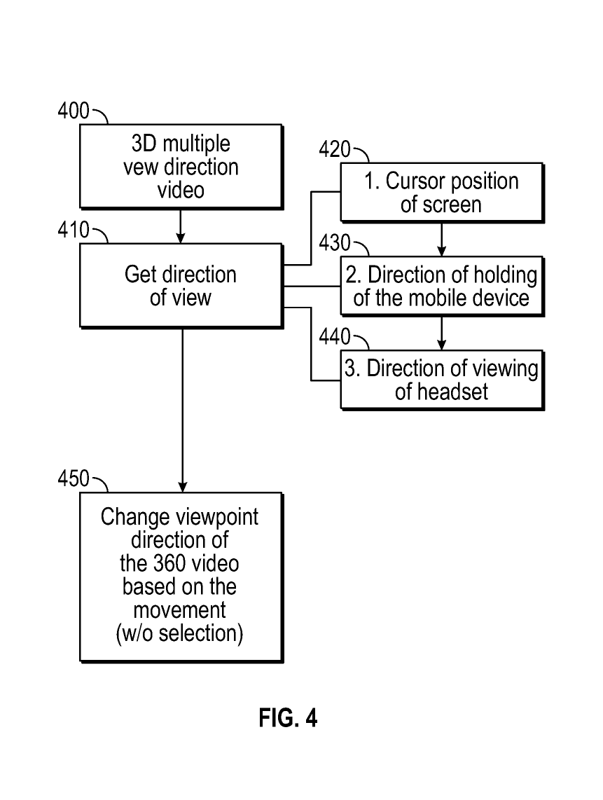

The operation is summarized in the flowchart of FIG. 4. FIG. 4 starts with step 400 in which there is a 3 dimensional multiple direction of viewing video.

At 410, the direction of viewing is obtained. This direction of viewing can be done in three different ways according to three different embodiments.

The first way of viewing is shown as 420 where the position of the cursor on the screen sets the viewing direction on the screen. No selection is necessary, just moving the cursor changes the viewpoint.

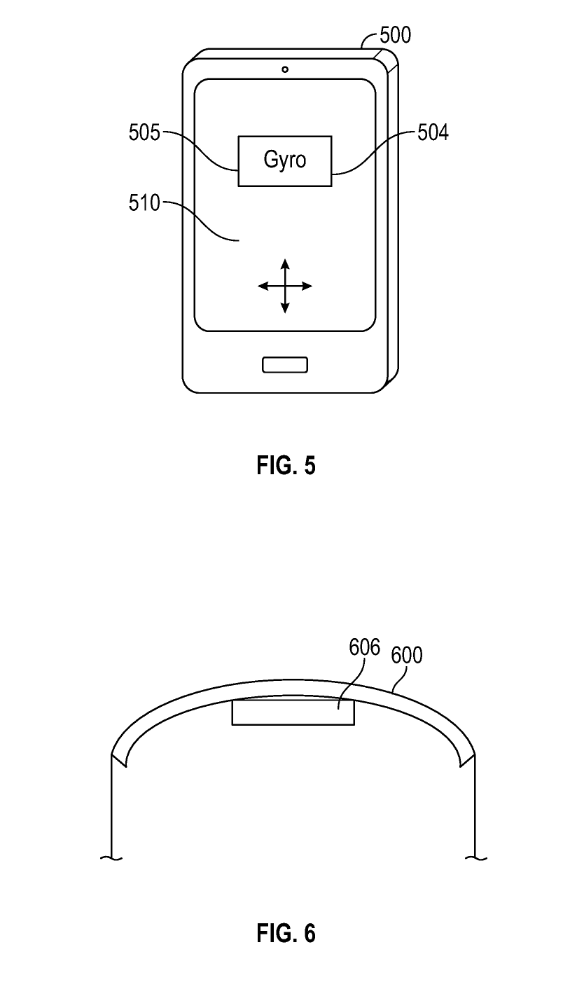

The hardware can alternatively be a mobile phone 500 as shown in FIG. 5, with a gyroscope 505 or other similar hardware that automatically detects the tilting position of the mobile phone 500. As the mobile phone tilts or rotates, for example moving the phone to face in different directions, the gyroscope 505 detects that the direction in which the mobile phone viewing has been changed. Step 420 represents this alternative embodiment where the direction of holding of the mobile phone 500 automatically sets the viewpoint of viewing of the three-dimensional video. The view seen on the screen 510 of the mobile phone automatically changes position, as in FIGS. 3A-3C, as the phone tilts.

Another embodiment uses a virtual reality headset 600 as in FIG. 6, that sits on the head of the user, e.g., covering the user's eyes. The virtual reality headset can be for example a headset that holds a mobile phone 605, or can be any other kind of headset. In this embodiment, however, the direction of viewing, that is the direction in which the headset is pointing (in both “pan”, e.g., 360 direction, and “tilt”, the up and down direction), automatically sets the direction of viewing of the three-dimensional video as in FIGS. 3A-3C, as the VR headset moves and tilts. If the VR headset includes a cellular phone, that phone can be held in place in front of a user's eyes, and where the cellular phone can run a program to display virtual-reality information, for a virtual reality headset, on the display of the cellular phone.

In all of these embodiments, as shown in 450, the direction of viewpoint of the 360° video changes based on the movement on the viewing device, without any selection necessary on the viewing device, just moving to a different angle sets this direction of viewing to be different.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example while the above describes only certain kinds of user interface devices, it should be understood that other kinds of devices may similarly be used.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

Any kind of processor or client can be used with this invention.

What is claimed is:

1. A system comprising:
a computer, having a user interface which can be moved between multiple different pointing directions;
a display, that displays an image, where the image includes information which enables viewing the image from multiple different directions, and
a processor, associated with said computer, which automatically changes the direction of viewing of the image between the multiple different directions based on
a current pointing direction of the user interface, without making a selection on the user interface other than its pointing.

2. The system as in claim 1, wherein the image is a frame of a video.

3. The system as in claim 2, wherein the video includes information for viewing from all directions around 360°.

4. The system as in claim 1, wherein the system is formed of a computer system that uses a mouse as the user interface, and the pointing direction is a direction of pointing of the mouse without a selection being made on the mouse.

5. The system as in claim 1, wherein the system is formed of a cellular phone, which has an electronic component that determines a direction of pointing of the cellular phone, and the direction of viewing of the image is set by the computer based on the direction of pointing of the cellular phone.

6. The system as in claim 5, wherein the cellular phone includes a structure for determining pan and tilt of the cellular phone, and the direction of viewing uses both the pan movement and tilt movement of the cellular phone to determine the direction of viewing.

7. The system as in claim 6, wherein the structure for determining pan and tilt includes a gyroscope.

8. The system as in claim 5, wherein the system includes virtual reality headset that holds the cellular phone in place in front of a user's eyes, and where the cellular phone runs a program to display virtual-reality information, for a virtual reality headset, on the display of the cellular phone.

9. The system as in claim 1, wherein the system is formed of a virtual reality headset that determines the direction in which the user is looking as a direction of pointing, and the direction of pointing automatically changes the direction of viewing of the image.

10. A method of viewing a multi-directional viewable image, comprising:
on a computer, accepting commands to a user interface, to point the user interface in one of multiple different pointing directions;
displaying an image on a display, where the image includes information which enables viewing the image from multiple different directions, and
automatically changing a direction of viewing of the image to a specific direction from among the multiple different directions based on a current pointing direction of the user interface, without making a selection on the user interface other than its pointing.

11. The method as in claim 10, wherein the image is a frame of a video.

12. The method as in claim 11, wherein the video includes information for viewing from all directions around 360°.

13. The method as in claim 11, wherein the user interface includes a mouse as the user interface, and the pointing direction is a direction of pointing of the mouse without a selection being made on the mouse.

14. The method as in claim 11, wherein the computer is formed of a cellular phone, which has an electronic component that determines a direction of pointing of the cellular phone, and the direction of viewing of the image is set by the computer based on the direction of pointing of the cellular phone.

15. The method as in claim 14, further comprising determining pan and tilt of the cellular phone, and setting the direction of viewing using both the pan movement and tilt movement of the cellular phone to determine the direction of viewing.

16. The method as in claim 11, the user interface is formed of a virtual reality headset that determines the direction in which the user is looking as a direction of pointing, and the direction of pointing automatically changes the direction of viewing of the image.
